(19) United States
(12) Patent Application Publication
(10) Pub. No.: US 2013/0057060 A1
(43) Pub. Date: Mar. 7, 2013

(54) DEVICE FOR CANCELING UNDESIRABLE MAGNETIC FIELD AROUND ON-LINE ELECTRIC VEHICLE, METHOD OF MANUFACTURING THE SAME, AND ON-LINE ELECTRIC VEHICLE CAPABLE OF CANCELING UNDESIRABLE MAGNETIC FIELD

(71) Applicants: Nam Pyo Suh, Daejeon (KR); Soon Heung Chang, Daejeon (KR); Dong Ho Cho, Seoul (KR); Jae Ha Yim, Daejeon (KR); Yang Bae Chun, Daejeon (KR)

(72) Inventors: Nam Pyo Suh, Daejeon (KR); Soon Heung Chang, Daejeon (KR); Dong Ho Cho, Seoul (KR); Jae Ha Yim, Daejeon (KR); Yang Bae Chun, Daejeon (KR)

(73) Assignee: KOREA ADVANCED INSTITUTE OF SCIENCE AND TECHNOLOGY, Daejeon (KR)

(21) Appl. No.: 13/501,682

(22) PCT Filed: Oct. 15, 2010
(86) PCT No.: PCT/KR2010/007102

§ 371 Date: Nov. 19, 2012

(30) Foreign Application Priority Data
Oct. 15, 2009 (KR) 10-2009-0098211

(51) Int. Cl. H02J 17/00; H01F 7/06

(52) U.S. Cl. 307/9.1; 29/605

(57) ABSTRACT

A method, for manufacturing a device for canceling an undesirable magnetic field around an on-line electric vehicle, the method comprising, calculating a primary magnetic field generated by a current flowing through a power line, calculating a first undesirable magnetic field, calculating a second undesirable magnetic field, obtaining an entire undesirable magnetic field by calculating a vector sum of the first and second undesirable magnetic fields, obtaining a number of turns of a coil to be wound around one end or both ends of the power acquisition device which maximally cancels the entire undesirable magnetic field, and winding the coil around the end or ends of the power acquisition device in accordance with the obtained number of turns, and short-circuiting each coil.

### TECHNICAL FIELD

The present invention relates to a effective cancellation of an undesirable magnetic field which is formed around an on-line electric vehicle and, more particularly, to a system and device which is capable of canceling undesirable magnetic field by winding a coil around the end or ends of the power acquisition device and short-circuiting each coil.

### BACKGROUND ART

FIG. 1 is a diagram schematically showing a power acquisition device 20, a power acquisition coil C2 wound inside the power acquisition device 20, and a power line 2 arranged below the power acquisition device 20. AC current is supplied to the power line 2. The power acquisition device 20 uses a magnetic field generated by the power line 2 to drive an on-line electric vehicle. That is, the power acquisition coil C2 induces current by using the magnetic field generated by the power line 2. Therefore power is supplied to the on-line electric vehicle using the induced current.

However, a part of the magnetic field is not induced into current and forms a first undesirable magnetic field, and a second undesirable magnetic field is formed by the current induced in the power acquisition coil C2. Such an undesirable magnetic field may exert influence on a driver or passengers riding in the vehicle or passengers waiting to ride the vehicle, or may cause failures or errors in adjacent electronic devices. Furthermore, the undesirable magnetic field may have a negative effect of reducing the efficiency of the power acquisition device 20.

This problem was presented not only in “Roadway Powered Electric Vehicle Project Track Construction and Testing Program, Phase 3D, Systems Control Technology, Inc. Palo Alto, Calif. [California PATH Research Paper, UCB-ITS-PRR-94-07]” but also in “Seminar for EMF Biological Effects on Human Body, Kim Nam, Department of Information and Communication Engineering, Chungbuk National University,” and “ICNIRP Guideline=IEC 62597=EN50500 Human Exposure, Paris, UIC HQ, 10-16, Dec. 10, 2008.”

### DISCLOSURE OF INVENTION

### Technical Problem

It is, therefore, an object of the present invention to provide a device in which a coil is wound around one end or both ends of a power acquisition device so that the device can cancel an undesirable magnetic field formed around an on-line electric vehicle, a method of manufacturing the device, and an on-line electric vehicle capable of canceling an undesirable magnetic field.

### Solution to Problem

In accordance with an embodiment of the present invention, there is provided a method for manufacturing a device for canceling an undesirable magnetic field around an on-line electric vehicle, the method comprising, calculating a primary magnetic field generated by a current flowing through a power line which supplies power to the vehicle equipped with a power acquisition device; calculating a first undesirable magnetic field which is a part of the primary magnetic field and does not induce a current in a power acquisition coil provided in the power acquisition device; calculating a second undesirable magnetic field which is generated by the current induced in the power acquisition coil; obtaining an entire undesirable magnetic field by calculating a vector sum of the first and second undesirable magnetic fields; obtaining a number of turns of a coil to be wound around one end or both ends of the power acquisition device which maximally cancels the entire undesirable magnetic field; and winding the coil around the end or ends of the power acquisition device in accordance with the obtained number of turns, and short-circuiting each coil.

In accordance with another embodiment of the present invention, there is provided a device for canceling an undesirable magnetic field around an on-line electric vehicle, the device comprising, a power acquisition device mounted on the vehicle equipped with a power acquisition coil for inducing a current by using a primary magnetic field generated by a power line; and a coil, wound around one end or both ends of the power acquisition device, for generating a magnetic field which is opposite from an entire undesirable magnetic field represented by a vector sum of a first undesirable magnetic field which is a part of the primary magnetic field and does not induce the current in the power acquisition coil and a second undesirable magnetic field which is generated by the current induced in the power acquisition coil, thereby canceling the entire undesirable magnetic field, wherein each coil is short-circuited.

In accordance with a further embodiment of the present invention, there is provided an on-line electric vehicle capable of canceling an undesirable magnetic field, the vehicle comprising, a power acquisition device including a power acquisition coil for inducing a current by using a primary magnetic field generated by a power line, wherein the induced current is an Alternating Current (AC) signal; a rectifier for rectifying the AC signal; an inverter, connected to the rectifier, for converting the rectified AC signal to an target AC signal having a target voltage and frequency and outputting the target AC signal; a driving means for receiving the target AC signal and generating a rotating force; and a coil, wound around one end or both ends of the power acquisition device, for generating a magnetic field which is opposite from an entire undesirable magnetic field represented by a vector sum of a first undesirable magnetic field which is a part of the primary magnetic field and does not induce the current in the power acquisition coil and a second undesirable magnetic field which is generated by current induced in the power acquisition coil, thereby canceling the entire undesirable magnetic field, wherein each coil is short-circuited.

### Advantageous Effects of Invention

With the device, method, and on-line electric vehicle of the present invention, an undesirable magnetic field which may be generated around the power acquisition device of an on-line electric vehicle can be canceled. This prevents the bad influences on a driver or passengers riding in the vehicle or passengers waiting to ride the vehicle and prevents failures or errors in adjacent electronic devices.

Furthermore, the efficiency of the power acquisition device can be enhanced.

### BRIEF DESCRIPTION OF DRAWINGS

The above and other objects and features of the present invention will become apparent from the following description of preferred embodiments given in conjunction with the accompanying drawings, in which:

FIG. 1 is a diagram schematically showing an power acquisition coil wound inside a power acquisition device and a power line arranged below the power acquisition coil;

FIG. 2 is a flowchart showing a method of manufacturing a device for canceling an undesirable magnetic field around an on-line electric vehicle;

FIG. 3 is a diagram showing a magnetic field formed around a power acquisition device and illustrating an undesirable magnetic field having a bar magnet-type magnetic field pattern formed around the power acquisition device;

FIG. 4 is a diagram schematically showing an embodiment of a device for canceling an undesirable magnetic field in which a coil is wound around both ends of a power acquisition device to cancel the undesirable magnetic field having a bar magnet-type magnetic field pattern according to the present invention;

FIG. 5 is a diagram showing the schematic configuration of an on-line electric vehicle capable of canceling an undesirable magnetic field according to the present invention;

FIG. 6 is a diagram showing an undesirable magnetic field around a conventional on-line electric vehicle; and

FIG. 7 is a diagram showing an undesirable magnetic field around an on-line electric vehicle capable of canceling a magnetic field according to the present invention.

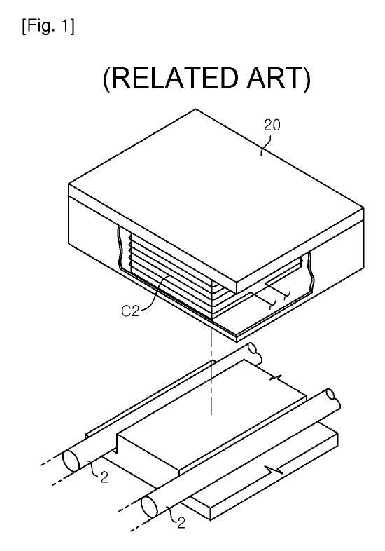

### BEST MODE FOR CARRYING OUT THE INVENTION

Hereinafter, preferred embodiments of the present invention will be described in detail with reference to the accompanying drawings so that they can be readily implemented by those skilled in the art. In the several Figures of the drawings, same reference numerals are used to designate same or equivalent elements, functions or components.

<Method of Manufacturing Device for Canceling Undesirable Magnetic Field Around On-line Electric Vehicle>

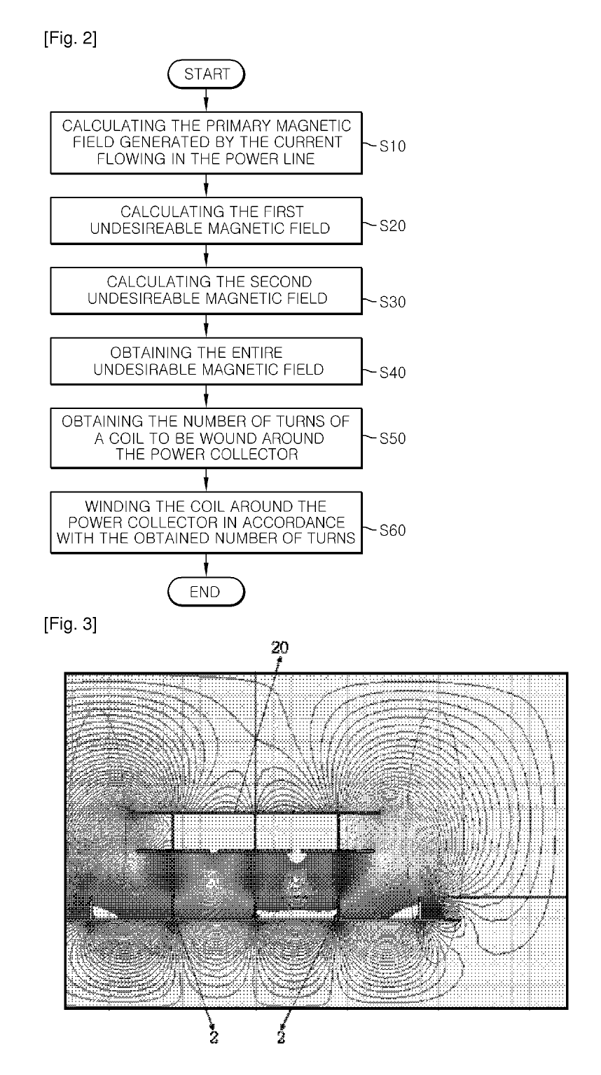

FIG. 2 is a flowchart showing a method of manufacturing a device for canceling an undesirable magnetic field around an on-line electric vehicle.

The entire undesirable magnetic field is represented as the vector sum of a first undesirable magnetic field and a second undesirable magnetic field. The first undesirable magnetic field is a magnetic field which is part of a primary magnetic field generated by a current flowing through a power line and does not induce current in the power acquisition coil. The second undesirable magnetic field is a magnetic field which is generated by the current induced in the power acquisition coil.

Referring to FIG. 2, the primary magnetic field generated by the power line which supplies power to an on-line electric vehicle equipped with a power acquisition device is calculated at step S10.

Here, although one of various values may be used as the value of the current applied to the power line, the power line in the present embodiment has a value of 200 A.

The analysis of a magnetic field is performed by obtaining magnetic flux density at an arbitrary point around the on-line vehicle. The magnetic flux density at an arbitrary point is obtained by using the following Equation:

$$B = \frac{{μ}_{0} I}{2 π ρ}$$

where B is magnetic flux density formed at an arbitrary point around an on-line vehicle, μ₀ is a permeability constant, I is a current value of each current source, and p is a distance from each current source to an arbitrary point.

Furthermore, the analysis of a magnetic field may also be performed by using ANSOFT's Maxwell software.

Thereafter, the first undesirable magnetic field which is a part of the primary magnetic field and does not induce current in the power acquisition coil is calculated at step S20.

Thereafter, the second undesirable magnetic field which is generated by the current induced in the power acquisition coil inside the power acquisition device is calculated at step S30.

Thereafter, the entire undesirable magnetic field is obtained by calculating the vector sum of the first and second undesirable magnetic fields at step S40.

Here, when analyzing a pattern of the entire undesirable magnetic field, a bar magnet-type magnetic field pattern is observed around the power acquisition device. In this case, step S40 of obtaining the entire undesirable magnetic field may be the step of simulating the vector sum of the first and second undesirable magnetic fields and visually outputting the pattern and intensity of the entire undesirable magnetic field on a display means.

Thereafter, the number of turns of a coil to be wound around one end or both ends of the power acquisition device which maximally cancels the calculated entire undesirable magnetic field is obtained at step S50.

Thereafter, the coil is wound around one end or both ends of the power acquisition device in accordance with the obtained number of turns, and each coil is short-circuited at step S60.

Here, the above step of winding the coil may be performed by selectively increasing or decreasing the number of turns of the coil while measuring the entire undesirable magnetic field through a predetermined magnetic field measuring means so as to cause the undesirable magnetic field to have a value equal to or lower than a reference value.

The method of manufacturing a device for canceling an undesirable magnetic field according to the present invention is configured to determine the number of turns and thickness of the coil to be wound around the power acquisition device based on the pattern and intensity of the entire undesirable magnetic field. In the present embodiment in which the power line has a current value of 200 A, the entire undesirable magnetic field can be minimized by winding an 800 Core 10 Square Litz Wire cable (manufactured by LS Cable Ltd.) five times.

By performing steps S10 to S60, undesirable magnetic fields formed around the on-line electric vehicle can be canceled.

<Device for Canceling Undesirable Magnetic Field>

FIG. 3 shows the entire undesirable magnetic field by using the ANSOFT's Maxwell software, which was obtained by outputting the intensity and distribution of a magnetic flux density around the power acquisition device 20 on a display means. From this diagram, it can be seen that an undesirable magnetic field having a bar magnet-type magnetic field pattern is formed around the power acquisition device.

As shown in FIG. 3, the power acquisition device 20 acts like a single bar magnet, forming an undesirable magnetic field through both ends of the power acquisition device 20. In the device for canceling an undesirable magnetic field according to the present invention, a coil is wound around both ends of the power acquisition device 20 to cancel the formed undesirable magnetic field, and current is induced in the coil by the undesirable magnetic field. A magnetic field which is opposite from the undesirable magnetic field is generated by the induced current flowing through the coil wound around both ends of the power acquisition device 20. Therefore, the undesirable magnetic field is canceled by the opposite magnetic field generated by the coil.

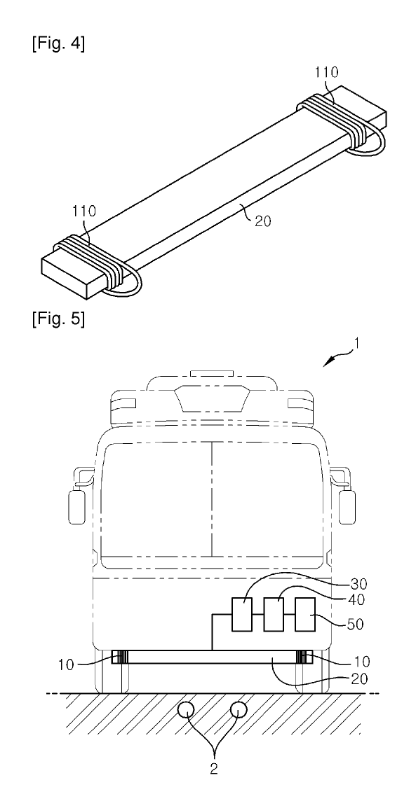

FIG. 4 is a diagram schematically showing an embodiment of a device for canceling an undesirable magnetic field in which the coil 110 is wound around both ends of the power acquisition device 20 to cancel an undesirable magnetic field having a bar magnet-type magnetic field pattern according to the present invention.

As shown in FIG. 4, a power acquisition device 20 may be implemented in the shape of a single bar magnet. Accordingly, when the pattern of an undesirable magnetic field is a bar magnet type, the device for canceling an undesirable magnetic field may be formed by winding the coil 110 around one end or both ends of the longitudinal axis of the power acquisition device 20. Furthermore, each coil 110 is short-circuited by connecting one tip with the opposite tip.

Although the coil 110 may be a coil including a single strand, it may also be a coil including a plurality of strands.

The coil 110 may be formed of a copper wire, or may be formed of a cable covered with an insulating film. The number of turns and thickness of a cable wound around the power acquisition device 20 are determined based on the pattern and intensity of the undesirable magnetic field. Analysis showed that in the present embodiment in which the power line has a current value of 200 A, the undesirable magnetic field could be minimized by winding an 800 Core 10 Square Litz Wire cable (manufactured by LS Cable Ltd.) five times.

Meanwhile, the coil 110 may be wound directly around a power acquisition coil (not shown) inside the power acquisition device 20, which cancels the undesirable magnetic field more effectively. However, in this case, the coil 110 and/or the power acquisition coil should be covered with an insulating film so that the power acquisition coil and the coil 110 are not electrically connected to each other.

<On-Line Electric Vehicle Capable of Canceling Undesirable Magnetic Field>

FIG. 5 is a diagram showing a configuration of an on-line electric vehicle according to the present invention. As shown in FIG. 5, the on-line electric vehicle capable of canceling an undesirable magnetic field 1 includes a power acquisition device 20 for receiving power, a rectifier 30 for stabilizing an AC signal, an inverter 40 for converting the AC signal to an AC signal having a target voltage and frequency, and a coil 10 for canceling an undesirable magnetic field.

The coil 10 for canceling the undesirable magnetic field has the same configuration as described above. Although the coil 10 for canceling the undesirable magnetic field may be exposed to the outside, as shown in FIG. 5, it may also be contained inside a casing along with a power acquisition coil (not shown).

The power acquisition device 20 includes a power acquisition coil (not shown) for inducing current by using a primary magnetic field generated by a power line 2 and further includes a casing.

The rectifier 30 stabilizes an AC signal induced in the power acquisition device 20 since the intensity of a magnetic field generated by the power line 20 is not constant. Meanwhile, the inverter 40 is connected to the rectifier 30, and converts the stabilized AC signal to an AC signal suitable for driving a motor. Furthermore, a driving means 50 receives the AC signal, and drives the on-line electric vehicle 1 using the AC signal.

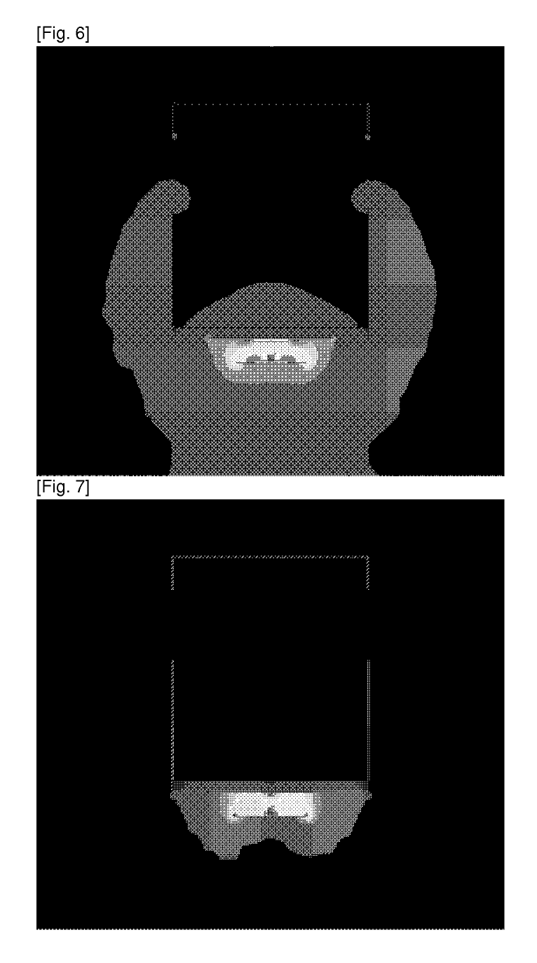

FIG. 6 is a drawing showing the simulation result of an undesirable magnetic field formed around a conventional on-line electric vehicle, and FIG. 7 is a drawing showing the simulation result of an undesirable magnetic field around an on-line electric vehicle capable of canceling a magnetic field according to the present invention.

As shown in FIG. 6, the undesirable magnetic field is formed in an area below the vehicle and extends from the bottom of the vehicle to the windows of the vehicle.

However, referring to FIG. 7, it is shown that since a magnetic field which is opposite from the undesirable magnetic field is generated by the current induced in the coil installed around both ends of the power acquisition device, the undesirable magnetic field has been cancelled and the magnetic field remains only in sections where it is necessary.

The above-described present invention has the advantages of, canceling an undesirable magnetic field which may be generated around the power acquisition device of an on-line electric vehicle, preventing bad influence on the driver and passengers riding in the on-line electric vehicle or passengers waiting to ride the on-line electric vehicle and preventing erroneous operations of adjacent electronic devices.

Furthermore, the above-described present invention has the advantage of enhancing the efficiency of the power acquisition device.

While the invention has been shown and described with respect to the preferred embodiments, it will be understood by those skilled in the art that various changes and modifications may be made without departing from the spirit and scope of the invention as defined in the following claims.

1. A method of manufacturing a device for canceling an undesirable magnetic field around an on-line electric vehicle, the method comprising:
calculating a primary magnetic field generated by a current flowing through a power line which supplies power to the vehicle equipped with a power acquisition device;
calculating a first undesirable magnetic field which is a part of the primary magnetic field and does not induce a current in a power acquisition coil provided in the power acquisition device;
calculating a second undesirable magnetic field which is generated by the current induced in the power acquisition coil;
obtaining an entire undesirable magnetic field by calculating a vector sum of the first and second undesirable magnetic fields;
obtaining a number of turns of a coil to be wound around one end or both ends of the power acquisition device which maximally cancels the entire undesirable magnetic field; and
winding the coil around the end or ends of the power acquisition device in accordance with the obtained number of turns, and short-circuiting each coil.

2. The method of claim 1, wherein the winding the coil is performed by winding an 800 Core 10 Square Litz Wire cable five times.

3. The method of claim 1, wherein the current flowing through the power line is 200 A.

4. The method of claim 1, wherein the obtaining the entire undesirable magnetic field is performed by simulating the vector sum of the first and second undesirable magnetic fields and outputting a pattern and intensity of the entire undesirable magnetic field on a display means.

5. The method of claim 1, wherein the entire undesirable magnetic field has a bar magnet-type magnetic field pattern formed around the power acquisition device.

6. The method of claim 1, wherein the winding the coil is performed by selectively increasing or decreasing the number of turns of the coil while measuring the entire undesirable magnetic field through a magnetic field measuring means so as to cause the entire undesirable magnetic field to have a value equal to or lower than a reference value.

7. A device for canceling an undesirable magnetic field around an on-line electric vehicle, the device comprising:
a power acquisition device mounted on the vehicle equipped with a power acquisition coil for inducing a current by using a primary magnetic field generated by a power line; and
a coil, wound around one end or both ends of the power acquisition device, for generating a magnetic field which is opposite from an entire undesirable magnetic field represented by a vector sum of a first undesirable magnetic field which is a part of the primary magnetic field and does not induce the current in the power acquisition coil and a second undesirable magnetic field which is generated by the current induced in the power acquisition coil, thereby canceling the entire undesirable magnetic field, wherein each coil is short-circuited.

8. The device of claim 7, wherein the power acquisition device is installed parallel to a bottom of the vehicle.

9. The device of claim 7, wherein the coils are a copper wire including one or more strands, and are wound one or more times around the power acquisition device.

10. The device of claim 7, wherein the coils are a cable including a copper wire and an insulating film which covers the copper wire.

11. The device of claim 10, wherein the cable is an 800 Core 10 Square Litz Wire cable, and is wound five times.

12. The device of claim 10, wherein the cables are wound around the power acquisition coil.

13. An on-line electric vehicle capable of canceling an undesirable magnetic field, the vehicle comprising:
a power acquisition device including a power acquisition coil for inducing a current by using a primary magnetic field generated by a power line, wherein the induced current is an Alternating Current (AC) signal;
a rectifier for rectifying the AC signal;
an inverter, connected to the rectifier, for converting the rectified AC signal to an target AC signal having a target voltage and frequency and outputting the target AC signal;
a driving means for receiving the target AC signal and generating a rotating force; and
a coil, wound around one end or both ends of the power acquisition device, for generating a magnetic field which is opposite from an entire undesirable magnetic field represented by a vector sum of a first undesirable magnetic field which is a part of the primary magnetic field and does not induce the current in the power acquisition coil and a second undesirable magnetic field which is generated by current induced in the power acquisition coil, thereby canceling the entire undesirable magnetic field, wherein each coil is short-circuited.
